(19) United States
(12) Patent Application Publication
(10) Pub. No.: US 2026/0228569 A1
(43) Pub. Date: Aug. 6, 2026

(54) METHOD AND APPARATUS FOR ORGANIZATIONAL KNOWLEDGE CAPTURE AND RETENTION

(71) Applicant: PRICEWATERHOUSECOOPERS LLP, Toronto (CA)

(72) Inventors: Vik PANT, Toronto (CA); Bahar SATELI, Montreal (CA); Michelle BOURGEOIS, Toronto (CA)

(21) Appl. No.: 19/530,455

(22) Filed: Feb. 5, 2026

(30) Foreign Application Priority Data
Feb. 5, 2025 (CA) 3264267

(51) Int. Cl. G06N 5/022; G06Q 10/067

(52) U.S. Cl. CPC G06N 5/022; G06Q 10/067

(57) ABSTRACT

A non-transitory computer-readable storage medium is disclosed, which is encoded with software. When executed by a data processor, it implements a knowledge integration layer comprising interfaces and corresponding logic. A first interface receives user inputs, a second allows communication with a data repository, and a third communicates with a Transformer-Based Generative AI Service. The logic is responsive to user input potentially constituting new knowledge not recorded in the data repository, generating a query to search the repository for associated recorded knowledge. It then generates a request for the Generative AI service to compare the new and recorded knowledge, outputting data that describes a knowledge delta. This delta data is stored in the repository.

### CROSS-REFERENCE TO RELATED APPLICATION

The present application claims the priority of Canadian Patent Application No. 3,264,267, filed on Feb. 5, 2025 and incorporated herein by reference.

### FIELD OF THE INVENTION

The present invention pertains to systems and methods for the dynamic capture and retention of knowledge within an organizational setting. This solution addresses the significant challenge of preserving and utilizing the extensive institutional knowledge possessed by the expert workforce while simultaneously enhancing operational efficiencies through Generative AI-powered support systems. This approach signifies a fundamental departure from conventional knowledge management methodologies towards an integrated, Generative AI-driven framework that operates in conjunction with daily organizational activities.

### BACKGROUND OF THE INVENTION

The success of many business organizations is predicated upon the cumulative accumulation of knowledge and experience, typically codified within business processes that employees follow to deliver services to clients, build products, or perform similar tasks. There is a critical challenge in the industry of preserving and leveraging the extensive institutional knowledge that exists within an organization's expert workforce. The nature of this business knowledge is inherently dynamic; thus, organizations must continuously develop methodologies to accumulate new knowledge as it is generated during routine operations.

Traditionally, the process involves manually recording events or conditions related to new knowledge and subsequently updating the codified business processes to reflect this new knowledge. This conventional approach, however, is time-consuming and may not be consistently adhered to by all individuals, as it demands significant time and effort, thereby detracting from primary business tasks. Consequently, a substantial portion of the newly generated knowledge is often lost or retained only in the memories of individual employees, leaving it unintegrated into the organization's formal knowledge repository.

Additionally, when new employees join the organization, they require education and training in the organization's business processes, best practices, and other elements not within their prior knowledge. This training process is both time-consuming and inefficient. Therefore, the challenge of imparting the collective wisdom of the business to new employees remains substantial.

### SUMMARY OF THE INVENTION

As embodied and broadly described herein, the invention provides a non-transitory storage medium encoded with software which when executed by a data processor implements a knowledge integration layer, comprising:
a) a first interface to receive user input;
b) a second interface allowing communication with a data repository;
c) a third interface for communication with a Transformer-Based Generative AI Service;
d) logic, which:
   a. is responsive to a user input conveying data potentially constituting new knowledge that is not recorded in the data repository to generate a query and search the data repository for data representative of recorded knowledge which is associated to the new knowledge;
   b. generate a request for the Generative AI service via the third interface to compare the data representative of the new knowledge with the data representative of the recorded knowledge and output data describing a knowledge delta between the recorded knowledge and the new knowledge;
   c. store the data representative of the knowledge delta in the data repository.

In a non-limiting and specific example of implementation, the Knowledge Integration Layer is configured for dynamically maintaining an up-to-date and comprehensive knowledge repository. It enables integrating new knowledge by generating queries to search for existing similar data and creating knowledge delta prompts that summarize differences between new and existing data. Users can then verify these deltas via the first interface and provide additional details, ensuring that all necessary new knowledge is accurately captured.

### BRIEF DESCRIPTION OF THE DRAWINGS

FIG. 1 is a schematic block diagram illustrating an apparatus for the systematic capture and retention of dynamically generated knowledge within a business organization during standard operational activities. The system comprises a plurality of interconnected modules designed to identify, validate, and codify new knowledge in real-time.

FIG. 2 is a flow diagram depicting a method for capturing, validating, and recording new knowledge. This method involves several stages, including the identification of relevant events or conditions, the validation of the newly generated knowledge, and the integration of this knowledge into the organization's formal repository.

### DESCRIPTION OF DETAILED EXAMPLE

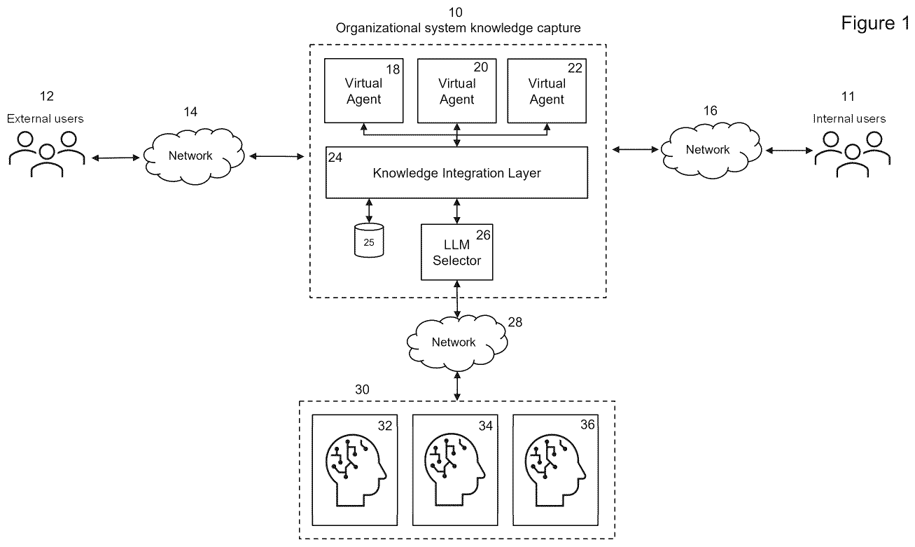

FIG. 1 is a schematic representation of a computer-implemented system (System 10) architected to capture knowledge in real-time as it is generated during the normal operational functions of a business organization. The system is designed to facilitate the unobtrusive acquisition of knowledge, thereby allowing users to allocate minimal effort towards the knowledge capture process while maintaining their primary focus on core business activities.

System 10 is designed to interface with internal users, who are typically employees engaged in delivering services or products to clients. During their activities, these internal users interact with the IT platform of the business organization via individual computers (not shown for simplicity), which are connected to a data network 16. This data network, in turn, connects to the organization's servers that run the requisite enterprise software. The internal users carry out various tasks on their computers, which may include exchanging emails with team members or clients, drafting text documents, working on spreadsheets, utilizing CAD software, accessing external databases, and performing numerous other tasks.

During the execution of these activities, internal users assimilate knowledge from both external and internal sources. They process this knowledge using their professional expertise and judgment, subsequently generating new knowledge that reflects their professional contributions. This new knowledge is then captured by system 10 in real-time, ensuring minimal disruption to the users'primary focus on core business activities. System 10 facilitates the seamless acquisition, validation, and codification of this dynamically generated knowledge, thereby augmenting the organization's formal knowledge repository, as it will be discussed below in more detail.

The system 10 is further configured to interface with external users 12, which may include, but are not limited to, clients of the business organization. In an exemplary embodiment, external users 12 may interact with the system 10 by submitting requests, thereby transmitting knowledge to the system 10 and receiving knowledge from the system 10 in return. This bidirectional exchange of information facilitates the continuous flow of knowledge between the external users and the system 10.

Consequently, system 10 is designed to dynamically identify instances of potentially new knowledge generated during these interactions. Upon identification, system 10 proceeds to validate the newly generated knowledge to ensure its authenticity and relevance. Once validated, system 10 records the new knowledge in an appropriate repository, such as a database or similar storage medium, thereby systematically augmenting the organization's formal knowledge repository.

The technical advantages provided by the system 10 include the seamless integration of knowledge capture within the normal operational activities of both internal and external users, minimizing the disruption to their primary business tasks. Additionally, the system 10 ensures the preservation of valuable knowledge that would otherwise be lost or retained only in the personal recollections of individual employees, thereby enhancing the organization's overall knowledge management and retention capabilities.

As previously indicated, system 10 is incorporated into the IT infrastructure of the business organization. The system 10 comprises a plurality of interconnected modules, each configured to execute specific functions in software, which is deployed on data processing hardware to realize its operational objectives. The hardware, while conventional in nature, provides the necessary computational resources to support the software modules.

The interconnected modules include an agentic functional block comprising a series of virtual agents 18, 20, 22 which provide support services to users 11, 12. A virtual agent based on Generative AI, such as Transformer-based Generative AI platform, functions as an intelligent assistant designed to facilitate various tasks and interactions with the individual user. These virtual agents can process queries, process vast amounts of data, analyze user inputs, and generate meaningful responses or actions in real-time. In a specific example, they are capable of:
Natural Language Processing and Understanding: Virtual agents can comprehend and respond to user inputs in natural language, making interactions intuitive and user-friendly.
Contextual Awareness: They maintain context throughout interactions, allowing for seamless and coherent communication across multiple exchanges.
Knowledge Retrieval: Virtual agents can access and retrieve relevant information from the organization's knowledge repository or external databases, providing users with precise and timely information.
Decision Support: By analyzing data and user inputs, virtual agents can offer insights and recommendations, aiding users in making informed decisions.
Task Automation: They can automate routine tasks such as scheduling meetings, drafting documents, and processing requests, thereby enhancing operational efficiency.

In the embodiment illustrated, the virtual agents 18, 20, and 22 are specialized software entities that may be selectively invoked based on the task being executed. Each virtual agent is programmed to be proficient in a specific domain of expertise, thereby providing a deeper and more comprehensive understanding of knowledge and context within its field. The number and specialization of the virtual agents can be configured according to the intended application. For example, within the context of a business organization providing financial services to clients, the virtual agents 18, 20, and 22 may include the following specialized functions:
1) A financial services administration agent 18, which is configured to handle the details of financial calculations and client services. This component is equipped with the capability to comprehend and apply regulatory requirements while encapsulating the nuanced approaches developed by the administrators of the business organization for handling complex cases. The agent utilizes machine learning algorithms to progressively build a comprehensive knowledge base encompassing both standard procedures and exception handling methodologies.
2) A risk management agent 20, which functions as a repository and advisor for risk assessment and management practices. This component integrates formal risk management frameworks with the experiential knowledge of the organization's risk managers, creating a dynamic resource that amalgamates theoretical principles with practical applications. The agent continuously learns from risk-related decisions and their outcomes, thereby constructing an increasingly sophisticated understanding of the organization's risk management protocols.
3) An operations assistant agent 22, which is designed to optimize workflow management and operational procedures. This component captures and preserves best practices through continuous interactions, identifying both formal processes and informal workflows that experienced staff have developed over time. The agent ensures that operational efficiency improvements are documented and disseminated across the organization, thus maintaining a high standard of operational excellence.

The virtual agents 18, 20, and 22 are preferably implemented using Transformer-based Generative AI technology. In the embodiment illustrated in FIG. 1, the virtual agents 18, 20, and 22 interface with a Transformer-Based Generative AI Service 30, which is preferably hosted on a cloud platform and communicates with the system 10 via a suitable data network 28. The Transformer-Based Generative AI Service 30 includes a plurality of Large Language Models (LLMs) 32, 34, and 36, each specialized in distinct fields. Consequently, each virtual agent 18, 20, and 22 is supported by a corresponding specialized LLM, although configurations are possible wherein a single, comprehensive LLM supports the functions of all virtual agents 18, 20, and 22.

Upon invocation of a virtual agent 18, 20, or 22, it receives a query, which may be manually input by a user or automatically input. The software logic of the virtual agent 18, 20, or 22 formulates a prompt which is transmitted to the Generative AI service 30. This prompt is processed by an LLM selector 26, which routes the prompt to the appropriate LLM 32, 34, or 36, in instances where individual, specialized LLMs are allocated to the virtual agents 18, 20, and 22. The LLM selector 26 functions by identifying the source virtual agent 18, 20, or 22 from which the request originates and tagging the request with an identifier of the corresponding LLM. Thus, when the Transformer-Based Generative AI Service 30 receives the request, it can accurately route it to the designated LLM.

The response generated by the LLM is routed back in the same way, through the network 28 to the originating vertical agent 18, 20, 22 where it can be delivered to the user.

In an alternative embodiment, the system 10 comprises a virtual agent selector (not shown in FIG. 1) configured to receive an inquiry and to selectively invoke one of the virtual agents 18, 20, or 22 to which the inquiry should be directed. This virtual agent selector may be implemented using Generative AI and operates by generating a prompt that includes the inquiry and a list of the virtual agents 18, 20, and 22, along with instructions to associate the inquiry with one of the virtual agents. The response generated by the Large Language Model (LLM) thus includes a selection of a virtual agent. In response to this selection, the virtual agent selector invokes the selected virtual agent 18, 20, or 22 and inputs the inquiry into the selected virtual agent, thereby enabling the selected virtual agent to process the inquiry.

The virtual agent selector is advantageous because it obviates the need for the user to manually select an individual virtual agent 18, 20, or 22. In this particular implementation, there is a single virtual agent, insulating the user from the selection process of the specific virtual agent 18, 20, 22. In an alternative variation, the user may be notified of the virtual agent selection made by the virtual agent selector and asked to confirm the selection. This can be effectuated by providing a Graphical User Interface (GUI) with graphical controls enabling the user to interact with the virtual agent selector. The GUI displays a control allowing the user to submit the query and, in response, presents the selection of the virtual agent to which the request will be directed. The user is then prompted to confirm the selection or indicate that the selection is incorrect via input on the GUI.

While not illustrated in the accompanying drawings, it should be appreciated that the virtual agents 18, 20, and 22 are configured to interface with one or more databases containing relevant information necessary for generating comprehensive responses. In the context of a financial services organization, such databases would typically include financial data pertaining to the clients of the organization, such as account information, transaction histories, and other pertinent financial records. Upon receiving a query, the virtual agent 18, 20, or 22 initially processes the input using the Generative AI service 30, which performs natural language processing to ascertain the intent behind the query. The Generative AI service 30 may then formulate a database query based on the determined intent, which is subsequently transmitted back to the virtual agent 18, 20, or 22.

The virtual agent 18, 20, or 22 utilizes this formulated database query to access the relevant database and retrieve the necessary financial data. This retrieved data is then communicated back to the Generative AI service 30, ensuring that the contextual continuity of the conversation is maintained. The Generative AI service 30 synthesizes the retrieved data with the original query, generating a coherent and user-friendly response that integrates the financial information. This synthesized response is then presented to the user, completing the interaction in a manner that leverages both the data retrieval capabilities of the virtual agents 18, 20, and 22 and the advanced natural language processing capabilities of the Transformer-Based Generative AI Service 30.

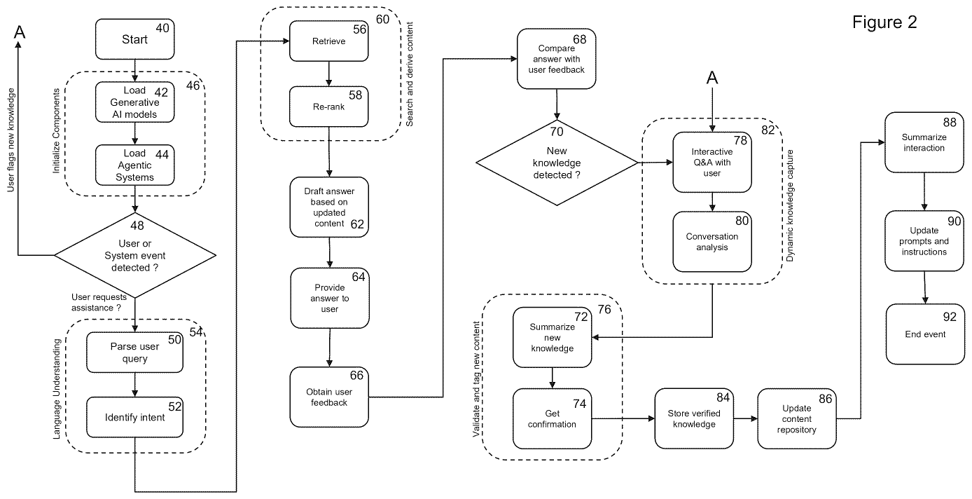

The system 10 further includes a Knowledge Integration Layer 24, which taps into the communication flow between the virtual agents 18, 20, 22 and the Transformer-Based Generative AI Service 30, interprets the different communications and detects whether a new knowledge is being generated and in the affirmative updates a knowledge repository 25. As with the other modules of the system 10, the Knowledge Integration Layer 24 is software based. The functionality of the Knowledge Integration Layer 24 will be described in more detail with the assistance of the flowchart at FIG. 2, which illustrates the different steps occurring during a knowledge capture transaction.

The Knowledge Integration Layer 24 processes communications to ascertain whether they constitute new knowledge. Upon confirmation that new knowledge is being generated, the Knowledge Integration Layer 24 initiates a protocol to update the knowledge repository 25, ensuring that the repository maintains an up-to-date and comprehensive knowledge base.

The operation of the Knowledge Integration Layer 24 will be described with reference to the flowchart depicted in FIG. 2, which illustrates the sequential steps involved in a typical transaction.

The process is initiated at step 40, followed by an initialization phase at step 46 where the various Transformer-based Generative AI models are instantiated at step 42 and the distinct agentic systems are initialized at step 44. Upon completion of steps 42 and 44, the virtual agents 18, 20, 22 are rendered active and primed to accommodate user input. As previously delineated, the user input may originate from external entities 12, typically in the form of a client inquiry seeking financial information pertinent to the user. Additionally, user input may also be generated by internal users 11 in the context of service delivery or the execution of other relevant tasks.

Step 48 is a decision step at which a user input or a system event is detected that requires the intervention of the Knowledge Integration Layer 24. In one possible example, a user can initiate the submission of new knowledge to the system and thereby trigger the operation of the Knowledge Integration Layer 24. This would typically occur in the case of an internal user who is aware of new knowledge and wishes to make a voluntary knowledge submission to record it within the knowledge repository 25. The Knowledge Integration Layer 24 can be invoked by users via the GUI. By activating a control on the GUI, the Knowledge Integration Layer 24 triggers a knowledge capture control where the user can enter the new knowledge. An example of a knowledge capture control can be a text box, where the user can type in free-form text the new knowledge or upload documents, such as text documents. Alternatively, the new knowledge can be submitted via voice and converted to text by speech recognition technology. Additionally, the user can assist with categorizing the new knowledge. For example, the knowledge capture box can be provided with a category selector, where the user can specify the category to which the new knowledge belongs and then submit the information. The category selector lists, or more generally identifies, a number of possible categories, and the user is enabled through the GUI to select one or more categories from the list. Once this initial input is provided by the user, the user input is conveyed to the Knowledge Integration Layer 24, and processing continues with step 82 (as shown by A) in the flowchart of FIG. 2. The Knowledge Integration Layer advantageously includes logic to develop a conversation with the user to capture the new knowledge as thoroughly as possible. Based on the initial input by the user, which can be the knowledge in text, voice, or another modality, including possibly a category selection, the system can ask additional questions to elicit a more complete response.

To elaborate, the Knowledge Integration Layer 24, in this specific example, is driven by the Transformer-Based Generative AI Service 30 to establish a meaningful conversation with the user and to capture the new knowledge in the most complete way possible without imposing a major time burden on the user. This is identified by steps 78 and 80 at FIG. 2. Accordingly, the logic that implements the Knowledge Integration Layer 24 is configured to generate a prompt, in response to receiving the user input, to trigger a knowledge capture conversation with the user and to capture the knowledge.

At step 76, the Knowledge Integration Layer 24 performs a validation of the new knowledge before storing it into the repository 25. One form of validation is the determination if the knowledge is new or if it has previously been recorded, in which case the knowledge is not new and does not need to be recorded again. To perform this validation step, the Knowledge Integration Layer 24 as an initial step tries to map the information received from the user to previously recorded knowledge in the repository 25. The Knowledge Integration Layer 24 will perform a search in the repository 25 to extract previously recorded knowledge that is the most closely related to the new knowledge submitted by the user. Next, the Knowledge Integration Layer 24 compares the recorded knowledge with the presumed new knowledge to generate a knowledge delta which represents the difference between what already exists in the repository 25 and what is allegedly new.

The determination of the knowledge delta is performed through a sequence of successive operations. In a first operation, information received from a user, including one or more knowledge categories and data representative of purported new knowledge, is processed to generate a query for searching the knowledge repository 25 for associated pre-existing knowledge. The query may be formulated using semantic search techniques, keyword-based search techniques, or a combination thereof, and is executed against the repository 25 to retrieve data representative of matching recorded knowledge.

The retrieved pre-existing knowledge is then associated with the data representative of the purported new knowledge. Both the new knowledge and the associated pre-existing knowledge are incorporated into a prompt that includes instructions to determine and summarize differences therebetween. The prompt is transmitted to a Transformer-based Generative AI service 30, which processes the prompt and outputs data representative of a knowledge delta describing differences between the pre-existing knowledge and the new knowledge. This operation corresponds to step 72 of the flowchart.

In one possible variant, the knowledge delta can be submitted to the user to get user input that the knowledge delta, which represents the actual new knowledge is indeed correct and nothing has been missed. The knowledge delta can be presented to the user via the GUI through the appropriate control, which allows the user to submit input to confirm the correctness of the knowledge delta and/or submit additional information to supplement the knowledge delta identified by the system.

The process can be iterative. The supplemental new knowledge submitted by the user is added to the knowledge delta, the repository 25 is queried again, and an updated knowledge delta is generated and presented to the user for confirmation. This process is repeated as many times as necessary until the user indicates that the new knowledge delta is complete, and there is nothing else the user can contribute.

For example, consider a scenario where a user wants to input new market research data into the system. The Knowledge Integration Layer 24 would generate a query to search the repository 25 for any existing similar market research data. If the search results include relevant data, the Knowledge Integration Layer 24 will generate a knowledge delta prompt, summarizing differences between the new and existing data. The user can then verify the knowledge delta and provide additional details, such as specifying market segmentation or adding new data points. This iterative process continues until the user confirms that all necessary new knowledge has been captured accurately.

Another example involves a scenario where an internal user submits recent updates to regulatory compliance standards. The Knowledge Integration Layer 24 would search the repository 25 for previous compliance standards and generate a knowledge delta prompt to highlight the changes. The user can then review and confirm the knowledge delta, adding any specific guidelines or examples that pertain to the new standards. This ensures that the repository 25 is up to date with the latest regulatory information, and all new knowledge is thoroughly captured and validated.

In this manner, the Knowledge Integration Layer 24 ensures that the repository 25 maintains an up-to-date and comprehensive knowledge base.

Steps 88, 90 and 92 complete the knowledge capture process, in particular at those steps the interaction is summarized, prompts and instructions are updated, and the event ends.

Once the new knowledge has been validated, it is stored at step 84, and the knowledge repository 25 is updated at step 86. In one specific example, the knowledge repository 25 may be structured as a graph, where knowledge is represented as nodes and edges. When new knowledge is developed and needs to be stored in the repository 25, the existing graph is updated by adding new nodes and edges to represent the new knowledge and link it to the previous knowledge.

Steps 88, 90, and 92 complete the knowledge capture process. At these steps, the interaction is summarized, prompts and instructions are updated, and the event ends.

Referring back to decision step 48, the other branch of the decision is executed when an external user interacts with the system to seek answers to their inquiries. For instance, the inquiry might pertain to a financial account managed by the business organization.

At step 54, the input from the user, provided via a text box on a GUI or another mechanism, is analyzed. Specifically, at sub-step 50, the user query is parsed and further processed at step 52 to identify the intent. Next, at step 60, a search is conducted in the financial data databases to extract the necessary information. More precisely, at sub-step 56, the results are retrieved, and at sub-step 58, the results are re-ranked.

At step 62, a response is generated based on the search results, which may involve the Generative AI service 30 to provide a coherent and easily understandable statement. This response is delivered to the user at step 64, and at step 66, user feedback is collected.

The response and user feedback are compared at step 68 to determine if any new knowledge conveyed by the user feedback may not be part of the response. This new knowledge is processed as previously described.

Although specific embodiments of the invention have been described and illustrated, it will be appreciated by those skilled in the art that various modifications, substitutions, and changes may be made without departing from the scope of the invention as defined by the appended claims. The described embodiments are intended to be illustrative rather than limiting, and the scope of the invention is defined solely by the claims. Any feature described in connection with one embodiment may be used in combination with features of other embodiments, even if not explicitly described, and all such combinations are contemplated herein.

1) A non-transitory computer-readable storage medium encoded with software which, when executed by at least one data processor, causes the at least one data processor to implement a knowledge integration layer, comprising:
a) a first interface configured to receive user input;
b) a second interface configured to communicate with a data repository;
c) a third interface configured to communicate with a Transformer-Based Generative AI Service; and
d) logic configured to:
i) in response to the user input conveying data potentially constituting new knowledge that is not recorded in the data repository, generate a query and search the data repository for data representative of recorded knowledge associated with the new knowledge;
ii) generate, via the third interface, a request to the Transformer-Based Generative AI Service to compare the data representative of the new knowledge with the data representative of the recorded knowledge and to output data describing a knowledge delta between the recorded knowledge and the new knowledge; and
iii) store the data representative of the knowledge delta in the data repository.

2) The non-transitory computer-readable storage medium of claim 1, wherein the logic is further configured to generate a message conveying the data representative of the knowledge delta for presentation to a user via the first interface on a graphical user interface (GUI).

3) The non-transitory computer-readable storage medium of claim 2, wherein the GUI includes a control operable by the user to confirm correctness of the knowledge delta.

4) The non-transitory computer-readable storage medium of claim 3, wherein, in response to user actuation of the control to confirm correctness of the knowledge delta, the logic stores the data representative of the knowledge delta in the data repository.

5) The non-transitory computer-readable storage medium of claim 2, wherein the GUI is configured to accept additional user input conveying data that supplements the knowledge delta with additional knowledge.

6) The non-transitory computer-readable storage medium of claim 1, wherein generating the query comprises formulating the query using at least one of: (i) semantic search criteria, and (ii) keyword-based search criteria.

7) The non-transitory computer-readable storage medium of claim 1, wherein generating the request to the Transformer-Based Generative AI Service comprises generating a prompt that includes (i) the data representative of the new knowledge, (ii) the data representative of the recorded knowledge, and (iii) instructions to summarize differences between the new knowledge and the recorded knowledge to thereby produce the knowledge delta.

8) The non-transitory computer-readable storage medium of claim 1, wherein the data repository comprises a graph data structure in which knowledge is represented as nodes and edges, and wherein storing the data representative of the knowledge delta comprises updating the graph data structure by adding one or more nodes and/or edges representative of the knowledge delta.

9) The non-transitory computer-readable storage medium of claim 1, wherein the first interface is configured to receive the user input as speech, and the logic is configured to convert the speech to text using speech recognition prior to generating the query.

10. The non-transitory computer-readable storage medium of claim 5, wherein the logic is configured to iteratively: (i) incorporate the additional user input into the knowledge delta, (ii) re-query the data repository for associated recorded knowledge, (iii) generate an updated request to the Transformer-Based Generative AI Service to output an updated knowledge delta, and (iv) present the updated knowledge delta via the GUI for user confirmation, until the user indicates that the knowledge delta is complete.

11. A computer-implemented method for integrating knowledge, the method comprising:
a) receiving, via a first interface, user input conveying data potentially constituting new knowledge; generating, based on the user input, a query;
b) searching, via a second interface, a data repository using the query to retrieve data representative of recorded knowledge associated with the new knowledge;
c) generating, via a third interface, a request to a Transformer-Based Generative AI Service to compare the data representative of the new knowledge with the data representative of the recorded knowledge and to output data describing a knowledge delta between the recorded knowledge and the new knowledge; and
d) storing the data representative of the knowledge delta in the data repository.

12. The method of claim 11, further comprising generating a message conveying the data representative of the knowledge delta for presentation to a user via a graphical user interface (GUI).

13. The method of claim 12, wherein the GUI includes a control operable by the user to confirm correctness of the knowledge delta.

14. The method of claim 13, further comprising, in response to user actuation of the control to confirm correctness of the knowledge delta, storing the data representative of the knowledge delta in the data repository.

15. The method of claim 12, further comprising receiving additional user input, via the GUI, conveying data that supplements the knowledge delta with additional knowledge.

16. The method of claim 11, wherein generating the query comprises formulating the query using at least one of: semantic search criteria and keyword-based search criteria.

17. The method of claim 11, wherein generating the request to the Transformer-Based Generative AI Service comprises generating a prompt that includes the data representative of the new knowledge, the data representative of the recorded knowledge, and instructions to summarize differences between the new knowledge and the recorded knowledge to thereby produce the knowledge delta.

18. The method of claim 11, wherein the data repository comprises a graph data structure in which knowledge is represented as nodes and edges, and wherein storing the data representative of the knowledge delta comprises updating the graph data structure by adding one or more nodes and/or edges representative of the knowledge delta.

19. The method of claim 11, wherein receiving the user input comprises receiving speech and converting the speech to text using speech recognition prior to generating the query.

20. The method of claim 15, further comprising iteratively: incorporating the additional user input into the knowledge delta; re-generating the query and re-searching the data repository for recorded knowledge associated with the knowledge delta; generating an updated request to the Transformer-Based Generative AI Service to output an updated knowledge delta; and presenting the updated knowledge delta via the GUI for user confirmation, until the user indicates that the knowledge delta is complete.
